(19) United States
(12) Patent Application Publication
(10) Pub. No.: US 2010/0046599 A1
(43) Pub. Date: Feb. 25, 2010

(54) APPARATUS AND METHOD FOR ACQUIRING INITIAL COEFFICIENT OF DECISION FEEDBACK EQUALIZER USING FAST FOURIER TRANSFORM

(76) Inventors: Dong-Kyoo Kim, Daejon (KR); Joo-Ho Park, Daejon (KR); Kwang-Roh Park, Daejon (KR); Young-Jin Kang, Jeonbuk (KR); Jae-Young Kim, Daejon (KR)

Correspondence Address: LADAS & PARRY LLP, 224 SOUTH MICHIGAN AVENUE, SUITE 1600, CHICAGO, IL, 60604, US

(21) Appl. No.: 12/515,998

(22) PCT Filed: Oct. 16, 2007
(86) PCT No.: PCT/KR2007/005050

§ 371 Date: May 22, 2009

(30) Foreign Application Priority Data
Nov. 22, 2006 (KR) 10-2006-0115858

(51) Int. Cl. H04L 27/01

(52) U.S. Cl. 375/233

(57) ABSTRACT

Provided is an apparatus and method for acquiring an initial coefficient of a DFE using an FFT. The apparatus includes a channel impulse response estimating unit for estimating a non-causal impulse response by delaying a received signal of a time domain and transforming it into frequency domain signals; a feedforward filter coefficient acquisition unit for extracting a predetermined number of signals from the non-causal channel impulse response signals estimated by the channel impulse response estimating unit, and transforming the same into frequency domain signals to acquire an initial coefficient of a feedforward filter; and a feedback filter coefficient acquisition unit for transforming the non-causal channel impulse response signals estimated by the channel impulse response estimating unit into frequency domain signals, multiplying the same by the initial coefficient of the feedforward filter, and transforming the results of multiplication into time domain signals to calculate an initial coefficient of a feedback filter.

### TECHNICAL FIELD

The present invention relates to an apparatus and method for acquiring an initial coefficient of a DFE (Decision Feedback Equalizer) using an FFT (Fast Fourier Transform); and more particularly, to an apparatus and method for acquiring an initial coefficient of a DFE using an FFT, which estimates non-causal channel impulse response characteristics in a non-data section by using a limited preamble in a packet-based broadband wireless communication system, and acquires an initial coefficient of a DFE with a small calculation amount without performing a matrix operation using an FFT.

This work was supported by the Information Technology (IT) research and development program of the Korean Ministry of Information and Communication (MIC) and the Korean Institute for Information Technology Advancement (IITA) [2005-S-030-02, “The development of high data rate WPAN based very high-speed wireless home networking technology”].

### BACKGROUND ART

As the next-generation wireless communication technology develops and the level of service requirements increases, the importance of the role of the broadband wireless communication technology is increasing. In order to realize broadband wireless communications, a frequency-selective fading phenomenon that occurs over a wide transmission channel has to be effectively attenuated.

Thus, a broadband wireless communication system does not use an LE (Linear Equalizer) but uses a DFE which is a nonlinear equalizer. Such a DFE effectively performs equalization of a ‘deep-faded broadband’ channel generating a heavily distorted signal, unlike the LE.

However, the DFE has a drawback that the calculation amount is large because the algorithm for acquiring coefficients is complicated in comparison with the LE.

Generally, the DFE technique has been mainly used as a channel equalization technique of a wired communication receiver, such as ADSL (Asymmetric Digital Subscriber line). A wired communication channel does not almost change in its characteristics after an initialization process for acquiring a channel at an initial stage is carried out. This structure is suitable for using a DFE for acquiring an initial coefficient by performing a complicated operation.

On the contrary, an OFDM (Orthogonal Frequency Division Multiplexing) method is mainly used as a channel equalization technique of a broadband wireless communication receiver. The OFDM method is a method that divides a broadband channel into a large number of narrowband subchannels and transmits and receives signals therethrough. This method has a merit that utilizes an FFT with a small calculation amount O(nlogn) (where n is a number of data subchannels) by using narrowband inter-channel orthogonality.

However, the OFDM method is disadvantageous in that it is difficult to actually implement the method due to the problem of recovering inter-subchannel orthogonality for accurate synchronization between a transmitter and a receiver, the problem of PAPR (Peak to Average Power Ratio) that can be solved by the use of expensive high-performance analog parts and so on.

Another channel equalization technique of a broadband wireless communication receiver is an SC (Single-Carrier) method using a DFE. Such a SC method has a simple receiver structure and thus can be implemented without any drawback of the OFDM method.

In broadband wireless communications, channel characteristics abruptly change with time. Due to this, a packet-based transmission method of dividing data to be transmitted into packets having a short length for transmission is used. Therefore, the conventional DFE initial coefficient acquisition algorithm having a high complexity reduces the transmission rate of wireless communications because of a long algorithm driving delay time.

The conventional DFE initial coefficient acquisition algorithm has the following types.

First, there is an ‘MMSE (Minimum Mean Squared Error)-DFE)’ algorithm which is based on the estimation of channel response characteristics. In this method, response characteristics of a channel are estimated and a feedback filter coefficient of a DFE is acquired by using Cholesky Factorization. Then, a feedforward filter coefficient is acquired by inversion of a matrix.

The Cholesky Factorization is not suitable for implementing the ‘MMSE-DFE’ algorithm in an ASIC (Application Specific Integrated Circuit) because its high speed calculation method has a complexity of O(n²) and the inverse operation of a matrix has a complexity of O(n³)(where n denotes the order of the filters).

Second, there is a method of acquiring an initial coefficient of a DFE by applying an adaptive filter algorithm. In this method, coefficients of feedforward and feedback filters of the DFE are adaptively obtained directly by using an LMS (Least Mean Square) method or an RLS (Recursive Least Square) method.

Such an LMS method is not suitable as an initial coefficient acquisition algorithm because the adaptive performance is inferior. Further, the RLS method is not easy to actually implement because the complexity is O(n²) although the adaptive performance for initial coefficient acquisition is good.

To sum up, the aforementioned two DFE algorithms having a complexity of more than O(n²) are problematic that they are not suitable for use in a packet-based wireless communication receiver since they reduce the transmission rate of wireless communications.

Consequently, there is a need for a DFE initial coefficient acquisition method having the same calculation amount of O(nlogn) as the OFDM method.

### DISCLOSURE OF INVENTION

### Technical Problem

It is, therefore, an object of the present invention to provide an apparatus and method for acquiring an initial coefficient of a DFE using an FFT, which estimates non-causal channel impulse response characteristics in a non-data section by using a limited preamble in a packet-based broadband wireless communication system, and acquires an initial coefficient of a DFE with a small calculation amount by not performing a matrix operation using an FFT.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an apparatus for acquiring an initial coefficient of a DFE (Decision Feedback Equalizer) using an FFT (Fast Fourier Transform), including: a channel impulse response estimating unit for estimating a non-causal impulse response by delaying a received signal of a time domain and then transforming the same into frequency domain signals; a feedforward filter coefficient acquisition unit for extracting a predetermined number of signals from the non-causal channel impulse response signals estimated by the channel impulse response estimating unit, and transforming the same into frequency domain signals to acquire an initial coefficient of a feedforward filter; and a feedback filter coefficient acquisition unit for transforming the non-causal channel impulse response signals estimated by the channel impulse response estimating unit into frequency domain signals, multiplying the same by the initial coefficient of the feedforward filter acquired by a feedforward filter coefficient estimating unit, and transforming the results of multiplication into time domain signals to calculate an initial coefficient of a feedback filter.

In accordance with another aspect of the present invention, there is provided a method for acquiring an initial coefficient of a DFE using an FFT, including the steps of: a) estimating a non-causal impulse response by delaying a received signal of a time domain and then transforming the same into frequency domain signals; b) extracting a predetermined number of signals from the estimated non-causal channel impulse response signals, and transforming the same into frequency domain signals to acquire an initial coefficient of a feedforward filter; and c) transforming the estimated non-causal channel impulse response signals into frequency domain signals, multiplying the same by the acquired initial coefficient of the feedforward filter, and transforming the results of multiplication into time domain signals to calculate an initial coefficient of a feedback filter.

### ADVANTAGEOUS EFFECTS

As described above and will be discussed above, the present invention can estimate non-causal channel impulse response characteristics in a non-data section by using a limited preamble in a packet-based broadband wireless communication system, and acquire an initial coefficient of a decision-feedback equalizer with a small calculation amount without performing a matrix operation using an FFT.

In addition, the present invention is easy to implement because it has a complexity of O(nlogn) by using an FFT.

Furthermore, the present invention can reduce the occupying area of the algorithm because there is no need to use an operator such as CORDIC having a high occupancy by not performing a matrix operation.

### BRIEF DESCRIPTION OF THE DRAWINGS

FIG. 1 is a structural view showing one example of a wireless communication packet used in the present invention.

FIG. 2 is a view illustrating one example of a signal structure of the preamble section used in the present invention.

FIG. 3 is a block diagram illustrating one example of a DFE of a frequency region filtering type to which the present invention is applied.

FIG. 4 is a block diagram illustrating the configuration of an apparatus for acquiring an initial coefficient of a DFE using an FFT in accordance with an embodiment of the present invention.

FIG. 5 is a configuration diagram of one example of the channel impulse response estimator of the initial coefficient acquisition apparatus in accordance with the present invention.

FIG. 6 is an operation explanatory view of one example of the post-cursor eraser of the initial coefficient acquisition apparatus in accordance with the present invention.

FIG. 7 is a detailed circuit diagram of the feedforward filter of the initial coefficient acquisition apparatus in accordance with the present invention.

FIG. 8 is an operation explanatory view of one example of the feedback filter of the initial coefficient acquisition apparatus in accordance with the present invention.

FIG. 9 is an operation explanatory view of one example of the feedback filter coefficient calculator of the initial coefficient acquisition apparatus in accordance with the present invention.

FIGS. 10 to 12 are performance analysis views of the initial coefficient acquisition apparatus of a DFE using an FFT in accordance with the present invention.

FIG. 13 is a flowchart of a method for acquiring an initial coefficient of a DFE using an FFT in accordance with another embodiment of the present invention.

### BEST MODE FOR CARRYING OUT THE INVENTION

The advantages, features and aspects of the invention will become apparent from the following description of the embodiments with reference to the accompanying drawings, which is set forth hereinafter. By this, the present invention will be easily carried out by those skilled in the art. Further, in the following description, well-known arts will not be described in detail if it seems that they could obscure the invention in unnecessary detail. Hereinafter, preferred embodiments of the present invention will be set forth in detail with reference to the accompanying drawings.

FIG. 1 is a structural view illustrating one example of a wireless communication packet used in the present invention.

As shown in FIG. 1, a wireless communication packet used in the present invention is largely divided into a preamble section 100 and a data section 110. The preamble section 100 consists of a series of training sequences for acquiring synchronization of a received signal.

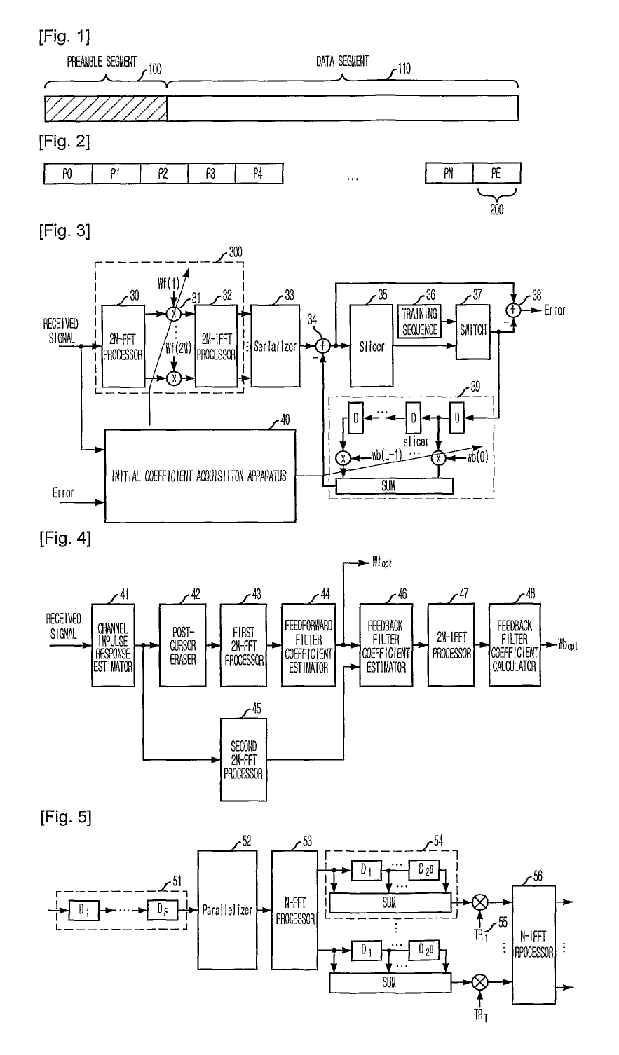

FIG. 2 is a view illustrating one example of a signal structure of the preamble section used in the present invention.

As shown in FIG. 2, the preamble section used in the present invention consists of a series of short training sequences. As one example of training sequences, CAZAC (Constant Amplitude Zero Auto Correlation) sequences use a sequence having a constant signal modulus and a high autocorrelation value. The code of the final training sequence 200 for detecting the end of the preamble section has an inversed value of the codes of other training sequences.

FIG. 3 is a block diagram illustrating one example of a DFE of a frequency region filtering type to which the present invention is applied.

As shown in FIG. 3, the DFE to which the present invention is applied includes a 2M-FFT processor 30 for transforming a received signal of a time domain into a frequency domain signal, a plurality of multipliers 31 for multiplying the frequency domain signal transformed by the 2M-FFT processor 30 by feedforward filter coefficients Wf(1) to Wf(2M), a 2M-IMFF processor 32 for inverse-transforming the results from the plurality of multipliers 31 into time domain signals, respectively, a serializer 33 for serializing the time domain signals inverse-transformed by the 2M-IFFT processor 32 into serial signals, respectively, an adder 34 for adding each of the time domain signals serialized by the serializer 32 and an output of a feedback filter 39, a slicer 35 for selecting one of predetermined signal points from an output of the adder 34 and outputting the same, a switch 37 for transferring a training sequence 36 to a subtractor 38 in a preamble section 100 and delivering an output from the slicer 35 to the subtractor 38 in a data section 110, the subtractor 38 for subtracting a value transmitted through the switch 37 from the output of the adder 34, the feedback filter 39 for filtering the output of the subtractor 38, and an initial coefficient acquisition apparatus 40 for estimating non-causal channel impulse response characteristics in a non-data section by using a limited preamble and acquiring an initial coefficient of the DFE with a small calculation amount without performing a matrix operation using an FFT.

This DFE of a frequency domain filtering type employs a feedforward filter of a frequency filtering type in order to reduce a calculation amount when acquiring an initial coefficient.

In the above DFE configuration, the 2M-FFT processor 30, the plurality of multipliers 31, and the 2M-IFFT processor 32 are referred to as the feedforward filter 300.

FIG. 4 is a block diagram illustrating the configuration of an apparatus for acquiring an initial coefficient of a DFE using an FFT in accordance with an embodiment of the present invention.

As shown in FIG. 4, the apparatus for acquiring an initial coefficient of a DFE using an FFT in accordance with the present invention includes a channel impulse response estimator 41 for estimating a non-causal impulse response by delaying a received signal of a time domain and then transforming it into frequency domain signals, a post-cursor eraser 42 for extracting a predetermined number of signals from the non-causal channel impulse response signals estimated by the channel impulse response estimator 41, a first 2M-FFT processor 43 for transforming the non-causal channel impulse response signals extracted by the post-cursor eraser 42 into frequency domain signals, an FFF (FeedForward Filter) coefficient estimator 44 for acquiring an initial coefficient Wfₒₚₜ of a feedforward filter 300 by using the non-causal channel impulse response signals of the frequency domain transformed by the first 2M-FFT processor 43, a second 2M-FFT processor 45 for transforming the non-causal channel impulse response signals estimated by the channel impulse response estimator 41 into frequency domain signals, an FBF (FeedBack Filter) coefficient estimator 46 for multiplying the corresponding frequency domain signals from the second 2M-FFT processor 45 by an initial coefficient of the feedforward filter 300 acquired by the feedforward filter coefficient estimator 44, a 2M-IFFT processor 47 for transforming the frequency domain output signals of the feedback filter coefficient estimator 46 into time domain signals, and a feedback filter coefficient calculator 48 for calculating an initial coefficient of the feedback filter 39 by using the time domain signals transformed by the 2M-IFFT processor 47.

Here, the post-cursor eraser 42, the first 2M-FFT processor 43, and the feedforward filter coefficient estimator 44 are referred to as a feedforward filter coefficient acquisition unit, and the feedfoward filter coefficient acquisition unit estimates an initial coefficient of the feedforward filter by the following equation 1.

Further, the feedback filter coefficient estimator 46, the 2M-IFFT processor 47, and the feedback filter coefficient calculator 48 are referred to as a feedback filter coefficient acquisition unit, and the feedback filter coefficient acquisition unit estimates an initial coefficient of the feedback filter by the following equation 2.

$$\begin{matrix}{W}_{f} ( k ) = \frac{{H}_{pre}^{*} ( k )}{{\vert {H}_{pre} ( k ) \vert}^{2} + 1 / SNR} & Eq . 1 \\ {w}_{b} = [ {\overline{w}}_{b , 2} {\overline{w}}_{b , 3} … {\overline{w}}_{b , L + 1} ] & Eq . 2\end{matrix}$$

wherein variables shown in the above Eqs. 1 and 2 are defined as follows:

$${H}_{pre} ( k ) = FFT \{ {h}_{pre , n} \}$$

$${h}_{pre} = ⌊ {h}_{pre , 1} {h}_{pre , 2} … {h}_{pre , M} ⌋ = [ {h}_{1} {h}_{2} … {h}_{F + 1} ]$$

$${h}_{n} = {IFFT}_{N} \{ \hat{H} ( k ) \} , \hat{H} ( k ) = {\sum }_{i = 1}^{I} {Y}_{i} ( k ) \times T ( k )$$

$${Y}_{i} ( k ) = {FFT}_{N} \{ y ( n - F - ( i - 1 ) R ) \} , R \text{:} Training sequence length$$

$$T ( k ) = \frac{1}{I \times {FFT}_{N} \{ {t}_{n } \}} , {t}_{n} \text{:} Training sequence$$

$${\overline{w}}_{b , n} = {IFFT}_{2 M} \{ {W}_{b} ( k ) \} , {\overline{w}}_{b} = ⌊ {\overline{w}}_{b , 1} {\overline{w}}_{b , 2} … {\overline{w}}_{b , 2 M} ⌋$$

$${W}_{b} ( k ) = {FFT}_{2 M} \{ {\overline{h}}_{n} \} \times {W}_{f} ( k ) , \overline{h} = [ {h}_{1} {h}_{2} … {h}_{N} {0}_{1 \times ( 2 M - N )} ]$$

FIG. 5 is a configuration diagram of one example of the channel impulse response estimator 41 of the initial coefficient acquisition apparatus in accordance with the present invention.

As shown in FIG. 5, the channel impulse response estimator 41 of the initial coefficient acquisition apparatus in accordance with the present invention includes a plurality of delay devices 51 for delaying a received signal for a predetermined time in order to obtain a non-causal channel impulse response, a parallelizer 52 for aligning received signals delayed by the delay devices 51 in parallel signals, an N-FFT processor 53 for transforming the received signals of the time domain parallelized by the parallelizer 52 into frequency domain signals, a plurality of adders 54 for adding each of frequency components of the signals transformed by the N-FFT processor 53, a multiplier 55 for multiplying output signals from the adders 54 by constants TR₁ to TR_{T}, respectively, and an N-IFFT processor 56 for inverse-transforming frequency domain signals, which are outputs of the multiplier 55, into time domain signals.

Here, the predetermined time corresponds to the number F of delay devices 51.

FIG. 6 is an operation explanatory view of one example of the post-cursor eraser 42 of the initial coefficient acquisition apparatus in accordance with the present invention.

As shown in FIG. 6, the post-cursor eraser 42 of the initial coefficient acquisition apparatus in accordance with the present invention extracts a predetermined number of signals from an N-number of parallel signals provided from the N-IFFT processor 56.

That is, an M-number of high-order input signals are outputted from the response signals estimated by the channel impulse response estimator 41, and an M-number of low-order input signals are outputted as 0. At this time, the value of M has the relationship as in the following equation 3 with respect to the number F of the delay devices 51.

M=F+1 Eq. 3

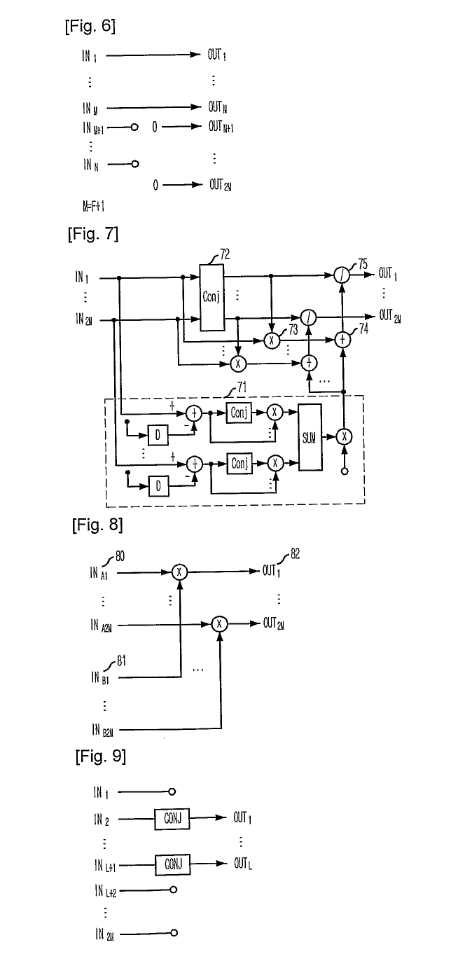

FIG. 7 is a configuration diagram of one example of the feedforward filter coefficient estimator 44 of the initial coefficient acquisition apparatus in accordance with the present invention.

As shown in FIG. 7, the feedforward filter coefficient estimator 44 of the initial coefficient acquisition apparatus in accordance with the present invention includes a noise variance estimator 71 for estimating a noise variance of each of the frequency domain signals from the first 2M-FFT processor 43, a conjugate calculator 72 for calculating a conjugate of each of the frequency domain signals from the first 2M-FFT processor 43, a multiplier 73 for multiplying the conjugate calculated by the conjugate calculator 72 by a corresponding one of the frequency domain signals from the first 2M-FFT processor 43, an adder 74 for adding the results of the multiplier 73 and the corresponding noise variance estimated by the noise variance estimator 71, and a divider 75 for dividing the conjugates calculated by the conjugate calculator 72 by the corresponding results of the adder 74 to acquire an initial coefficient Wfₒₚₜ of the feedforward filter 300.

FIG. 8 is an operation explanatory view of one example of the feedback filter coefficient estimator 46 of the initial coefficient acquisition apparatus in accordance with the present invention.

As shown in FIG. 8, the feedback filter coefficient estimator 46 of the initial coefficient acquisition apparatus in accordance with the present invention multiplies the initial coefficient of the feedforward filter 300, which is an output of the divider 75, by the corresponding frequency domain signals from the second 2M-FFT processor 45.

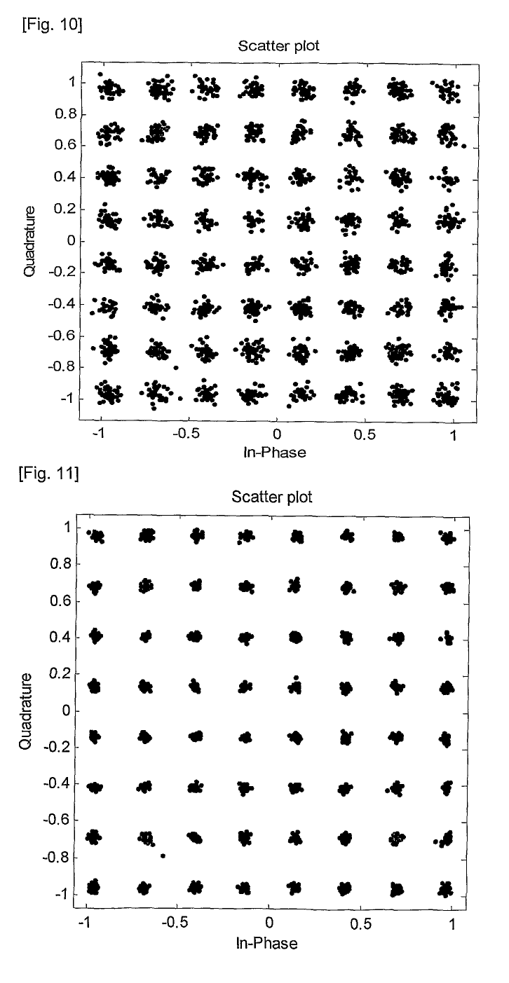

FIG. 9 is an operation explanatory view of one example of the feedback filter coefficient calculator 48 of the initial coefficient acquisition apparatus in accordance with the present invention.

As shown in FIG. 9, the feedback filter coefficient calculator (Shortener) 48 acquires an initial coefficient of the feedback filter 39 by using the time domain signals transformed by the 2M-IFFT processor 47.

That is, the feedback filter coefficient calculator 48 erases a signal firstly inputted from the time domain signals transformed by the 2M-IFFT processor 47, and calculates the conjugates of signals since the secondly inputted signal to output the same as the initial coefficient of the feedback filter 39.

FIGS. 10 to 12 are performance analysis views of the initial coefficient acquisition apparatus of a DFE using an FFT in accordance with the present invention.

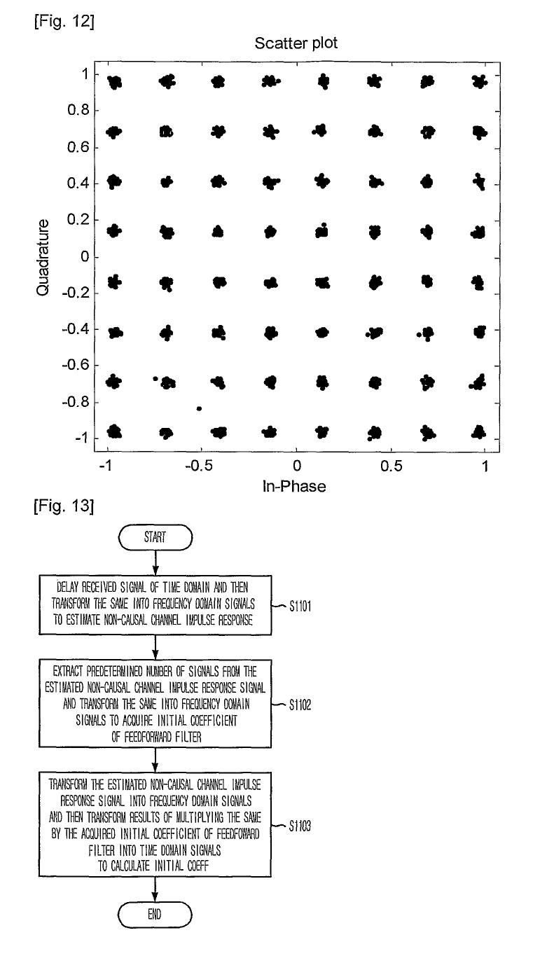

FIG. 10 shows an asteroid diagram of LMS-DFE, FIG. 11 shows an asteroid view of RLS-DFE, and FIG. 12 shows an asteroid view of the present invention.

At this time, the same training sequence is used.

By this, it can be seen that the present invention shows a superior performance to LMS-DFE and RLS-DFE.

FIG. 13 is a flowchart describing a method for acquiring an initial coefficient of a DFE using an FFT in accordance with another embodiment of the present invention.

First, a received signal of a time domain is delayed, and then transformed into frequency domain signals to estimate a non-causal channel impulse response in step S1101.

Thereafter, in step S1102, a predetermined number of signals are extracted from the estimated non-causal channel impulse response signals and then transformed into frequency domain signals, to acquire an initial coefficient of the feedforward filter.

In a next step S1103, the estimated non-causal channel impulse response signals are transformed into frequency domain signals, and then the results of multiplying the frequency domain signals by the acquired initial coefficient of the feedforward filter are transformed back into time domain signals, to thereby calculate an initial coefficient of the feedback filter.

By this procedure, an initial coefficient of the feedforward filter and an initial coefficient of the feedback filter are obtained with a small calculation amount.

The method of the present invention as described above may be implemented by a software program that is stored in a computer-readable storage medium such as CD-ROM, RAM, ROM, floppy disk, hard disk, optical magnetic disk, or the like. This process may be readily carried out by those skilled in the art, and therefore, details of thereof are omitted here.

The present application contains subject matter related to Korean Patent Application No. 2006-0115858, filed in the Korean Intellectual Property Office on Nov. 22, 2006 the entire contents of which are incorporated herein by reference.

While the present invention has been described with respect to the particular embodiments, it will be apparent to those skilled in the art that various changes and modifications may be made without departing from the spirit and scope of the invention as defined in the following claims.

1. An apparatus for acquiring an initial coefficient of a DFE (Decision Feedback Equalizer) using an FFT (Fast Fourier Transform), comprising:
a channel impulse response estimation means for estimating a non-causal impulse response by delaying a received signal of a time domain and then transforming the same into frequency domain signals;
a feedforward filter coefficient acquisition means for extracting a predetermined number of signals from the non-causal channel impulse response signals estimated by the channel impulse response estimating means, and transforming the same into frequency domain signals to acquire an initial coefficient of a feedforward filter; and
a feedback filter coefficient acquisition means for transforming the non-causal channel impulse response signals estimated by the channel impulse response estimating means into frequency domain signals, multiplying the same by the initial coefficient of the feedforward filter acquired by a feedforward filter coefficient estimating means, and transforming the results of multiplication into time domain signals to calculate an initial coefficient of a feedback filter.

2. The apparatus of claim 1, wherein the feedforward filter coefficient acquisition means includes:
a signal extracting means for extracting a predetermined number of signals from the non-causal channel impulse response signals estimated by the channel impulse response estimating means;
a first FFT processing means for transforming the non-causal channel impulse response signals extracted by the signal extracting means into frequency domain signals; and
a feedforward filter coefficient estimating means for acquiring an initial coefficient of the feedforward filter by using the non-causal channel impulse response signals of the frequency domain transformed by the first FFT processing means.

3. The apparatus of claim 2, wherein the feedforward filter coefficient acquisition means includes:
a second FFT processing means for transforming the non-causal channel impulse response signals estimated by the channel impulse response estimating means into frequency domain signals;
a feedback filter coefficient estimating means for multiplying the initial coefficient of the feedforward filter acquired by the feedforward filter coefficient estimating means by the corresponding frequency domain signals from the second FFT processing means;
an IFFT (Inverse FFT) processing means for transforming frequency domain output signals of the feedback filter coefficient estimating means into time domain signals; and
a feedback filter coefficient calculating means for calculating an initial coefficient of the feedback filter by using the time domain signals transformed by the IFFT processing means.

4. The apparatus of claim 3, wherein the channel impulse response estimating means includes:
a plurality of delay devices for delaying a received signal for a predetermined time;
a parallelizer for aligning received signals delayed by the delay devices in parallel signals;
an N-FFT processor for transforming the received signals of the time domain parallelized by the parallelizer into frequency domain signals;
a plurality of adders for adding each of frequency components of the signals transformed by the N-FFT processor;
a multiplier for multiplying output signals from the adders by constants; and
an N-IFFT processor for inverse-transforming frequency domain signals, which are outputs of the multiplier, into time domain signals.

5. The apparatus of claim 4, wherein the signal extracting means outputs an M-number of high-order input signals from the response signals estimated by the channel impulse response estimating means and outputs an M-number of low-order input signals as 0, and
wherein M and the number F of the delay devices have the relationship as follows:
M=F+1.

6. The apparatus of claim 5, wherein the feedforward filter coefficient estimating means includes:
a noise variance estimator for estimating a noise variance of each of the frequency domain signals provided from the first FFT processing means;
a conjugate calculator for calculating a conjugate of each of the frequency domain signals from the first FFT processing means;
a multiplier for multiplying each of the conjugates calculated by the conjugate calculator by the corresponding one of the frequency domain signals from the first FFT processing means;
an adder for adding the result of the multiplier and the noise variance estimated by the noise variance estimator; and
a divider for dividing the conjugate calculated by the conjugate calculator by the result of the adder to acquire an initial coefficient of the feedforward filters.

7. The apparatus of claim 6, wherein the feedback filter coefficient calculating means erases a signal firstly inputted from the time domain signals transformed by the IFFT processing means, and calculates conjugates of signals since a secondly inputted signal to output the same as the initial coefficient of the feedback filter.

8. A method for acquiring an initial coefficient of a DFE using an FFT, comprising the steps of:
a) estimating a non-causal impulse response by delaying a received signal of a time domain and then transforming the same into frequency domain signals;
b) extracting a predetermined number of signals from the estimated non-causal channel impulse response signals, and transforming the same into frequency domain signals to acquire an initial coefficient of a feedforward filter; and
c) transforming the estimated non-causal channel impulse response signals into frequency domain signals, multiplying the same by the acquired initial coefficient of the feedforward filter, and transforming the results of multiplication into time domain signals to calculate an initial coefficient of a feedback filter.

9. The method of claim 8, wherein the step b) includes the steps of:
b1) extracting a predetermined number of signals from the non-causal channel impulse response signals estimated in the step a);
b2) transforming the non-causal channel impulse response signals extracted in the step b1) into frequency domain signals; and
b3) acquiring an initial coefficient of the feedforward filter by using the non-causal channel impulse response signals of the frequency domain transformed in the step b2).

10. The method of claim 9, wherein the step b) further includes the steps of:
b4) transforming the non-causal channel impulse response signals estimated in the step a) into frequency domain signals;
b5) multiplying the initial coefficient of the feedforward filter acquired in the step b3) by the corresponding frequency domain signals;
b6) transforming frequency domain output signals of the step b3) into time domain signals; and
b7) calculating an initial coefficient of the feedback filter by using the transformed time domain signals.

11. The method of claim 10, wherein the step a) includes the steps of:
a1) delaying, at a plurality of delay devices, a received signal for a predetermined time;
a2) aligning delayed received signals in parallel signals;
a3) transforming the parallelized received signals of the time domain into frequency domain signals;
a4) adding each of frequency components of the transformed signals;
a5) multiplying an added signal of each of the frequency components by constants; and
a6) inverse-transforming frequency domain signals, which are multiplied by the constants, into time domain signals.

12. The method of claim 11, wherein the step b1) outputs an M-number of high-order input signals from the response signals estimated in the step a) and outputs an M-number of low-order input signals as 0, and wherein M and the number F of the delay devices have the relationship as follows:
M=F+1.

13. The method of claim 12, wherein the step b3) includes the steps of:
b3-1) estimating a noise variance of each of the frequency domain signals provided from the step b2);
b3-2) calculating a conjugate of each of the frequency domain signals from the step b2);
b3-3) multiplying each of the calculated conjugates by the corresponding one of the frequency domain signals from the step b2);
b3-4) adding the result of multiplication and the estimated noise variance; and
b3-5) dividing the calculated conjugate by the result of addition to acquire an initial coefficient of the feedforward filters.

14. The method of claim 13, wherein the step b7) erases a signal firstly inputted from the time domain signals transformed in the step b6), and calculates conjugates of signals since a secondly inputted signal to output the same as the initial coefficient of the feedback filter.
